(19) United States
(12) Patent Application Publication
(10) Pub. No.: US 2010/0116221 A1
(43) Pub. Date: May 13, 2010

(54) Animal Restraint System

(76) Inventor: Heather R. Falcon-Labry, Montgomery, TX (US)

Correspondence Address: HARSHAW RESEARCH, INC., 210 W. TECUMSEH STREET, OTTAWA, KS, 66067, US

(21) Appl. No.: 12/270,178

(22) Filed: Nov. 13, 2008

(51) Int. Cl. A01K 27/00

(52) U.S. Cl. 119/792

(57) ABSTRACT

An animal restraint system includes a vest configured to surround an animal extending from around the animal's neck. The vest includes front and rear ends, opposed first and second sides, a top, bottom, neck opening at the front end, two leg openings, and first and second shoulder areas. A ring is coupled to the vest at the first shoulder area, a first lateral loop is coupled to the vest at the top, and a first lateral loop is coupled to the vest at the first side. The system includes a first crossing loop. A strap is configured to pass through the first lateral loop and first crossing loop, respectively, the strap having opposed ends with fasteners. The strap extends along the first side when passing through the first lateral loop, the strap extending from the first to the second side when the strap passes through the first crossing loop.

### BACKGROUND OF THE INVENTION

This invention relates generally to animal restraint devices and, more particularly, to an animal restraint system for use in a vehicle that selectively restrains a pet. Further, the animal restraint system may be secured similar to a car seat, to the metal framework in the rear compartment of a vehicle, or in a truck bed.

Animals such as dogs are frequently transported in automobiles between a home and the veterinarian, to and from a park, or just to keep their owner company while traveling. Many pet owners desire to keep their pet restrained while driving either for the safety of the animal in case of an accident or so the pet does not interfere with the driver's ability to operate the vehicle safely.

Various devices have been proposed in the art for securely restraining a pet in a vehicle. Although assumably effective for their intended purposes, the existing devices are not adaptable for installation in cars, SUV's, and truck beds as well as useful for animals of multiple sizes while not taking away seating from human passengers.

Therefore, it would be desirable to have an animal restraint system that overcomes the limitations of the existing devices or prior patent proposals. Further, it would be desirable to have an animal restraint system that may be installed in multiple automobile environments, is adjustable for pets of various sizes, and includes a transition handle for controlling the pet when not secured in an automobile.

### SUMMARY OF THE INVENTION

An animal restraint system according to the present invention includes a vest configured to surround a forward portion of an animal extending from around the animal's neck to a location adjacent a rear end of the animal's rib cage. The vest includes front and rear ends, opposed first and second sides, a top, a bottom, a neck opening at the front end, two leg openings, and first and second shoulder areas, the shoulder areas being at the top generally adjacent the animal's shoulders when the vest is worn by the animal. A ring is coupled to the vest at the first shoulder area, a first lateral loop is coupled to the vest at the top, and a first lateral loop is coupled to the vest at the first side. The system includes a first crossing loop. A strap is configured to pass through the first lateral loop and the first crossing loop, respectively, the strap having opposed ends with fasteners configured for attachment to vehicle attachment points, the strap extending along the first side when the strap passes through the first lateral loop and the fasteners are utilized. The strap extends across the top from the first side to the second side when the strap passes through the first crossing loop and the fasteners are utilized.

Therefore, a general object of this invention is to provide an animal restraint system for securing an animal in a vehicle.

Another object of this invention is to provide an animal restraint system, as aforesaid, that is adaptable for installation in different vehicle environments.

Still another object of this invention is to provide an animal restraint system, as aforesaid, that may be reconfigured or adjusted for pets of various sizes.

A further object of this invention is to provide an animal restraint system, as aforesaid, that includes a transition handle for controlling the pet when not secured in an automobile.

A still further object of this invention is to provide an animal restraint system, as aforesaid, that is user-friendly to install and adjust.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an animal restraint system according to a preferred embodiment of the present invention, shown worn by a dog;

FIG. 2 is a perspective view of the animal restraint system as in FIG. 1 removed from the dog and on an enlarged scale;

FIG. 3 is a perspective of the animal restraint system as in FIG. 1, in another adjustment and secured configuration, such as adjacent a truck bed panel;

FIG. 4 is another perspective view of the animal restraint system as in FIG. 1, shown in another adjustment and secured configuration, such as in a truck bed;

FIG. 5a is another perspective view of the animal restraint system as in FIG. 1, shown in another adjustment and secured configuration, such as in a car seat;

FIG. 5b is an isolated view on an enlarged scale taken from a portion of FIG. 5a;

FIG. 5c is an isolated view on an enlarged scale taken from a portion of FIG. 5a;

FIG. 6a is a perspective view of an animal restraint system according to another embodiment of the present invention; and

FIG. 6b is an isolated view on an enlarged scale taken from a portion of FIG. 6a.

### DESCRIPTION OF THE PREFERRED EMBODIMENT

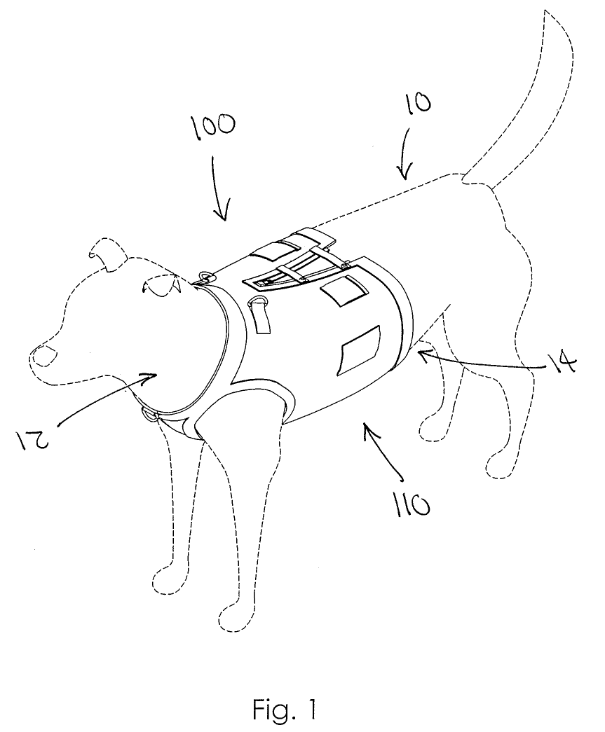

An animal restraint system will now be described in detail with reference to FIG. 1 through FIG. 6b of the accompanying drawings. More particularly, an animal restraint system 100 includes a vest 110 and a strap 150.

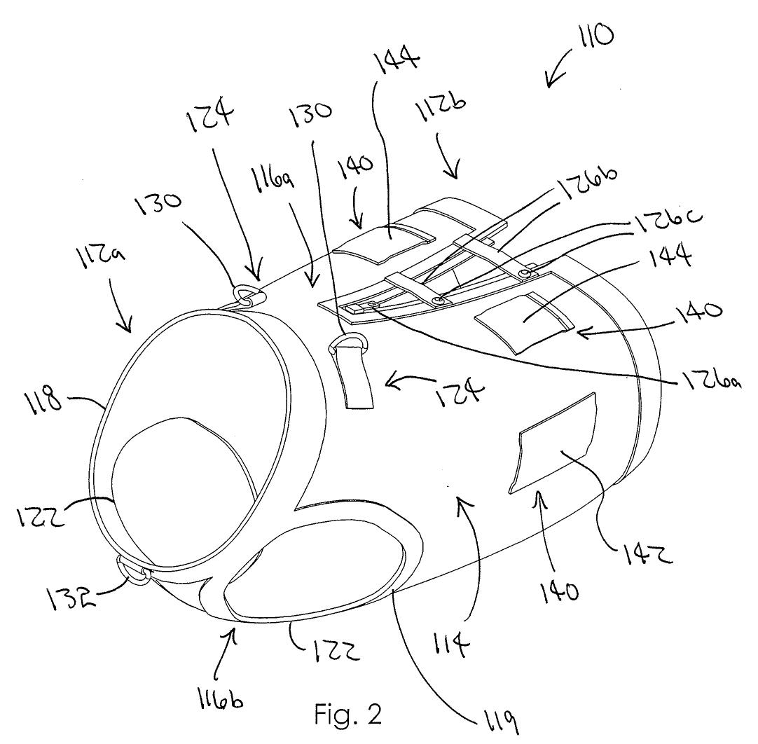

As shown in FIGS. 1 and 2, the vest 110 is configured to surround a forward portion of an animal 10 (e.g., a dog). More particularly, the vest 110 is configured to extend from the animal's neck 12 to a location adjacent a rear end of the animal's rib cage 14. The vest 110 includes front and rear ends 112a, 112b, opposed sides 114, a top 116a, a bottom 116b, a neck opening 118 at the front end 112a, two leg openings 122, and two shoulder areas 124. The shoulder areas 124 are at the top 116a generally adjacent the shoulders of the animal 10 when the vest 110 is worn by the animal 10. The vest 110 may include means for adjusting around the animal 10. For example, a zipper 126a, straps 126b with fasteners 126c, and/or other elements may be included to allow the vest 110 to be easily fitted to the animal 10. The vest 110 may be constructed of quilted fabric and/or any other appropriate material and may include reinforcing 119 (FIG. 2) adjacent the neck opening 118 and the leg openings 122.

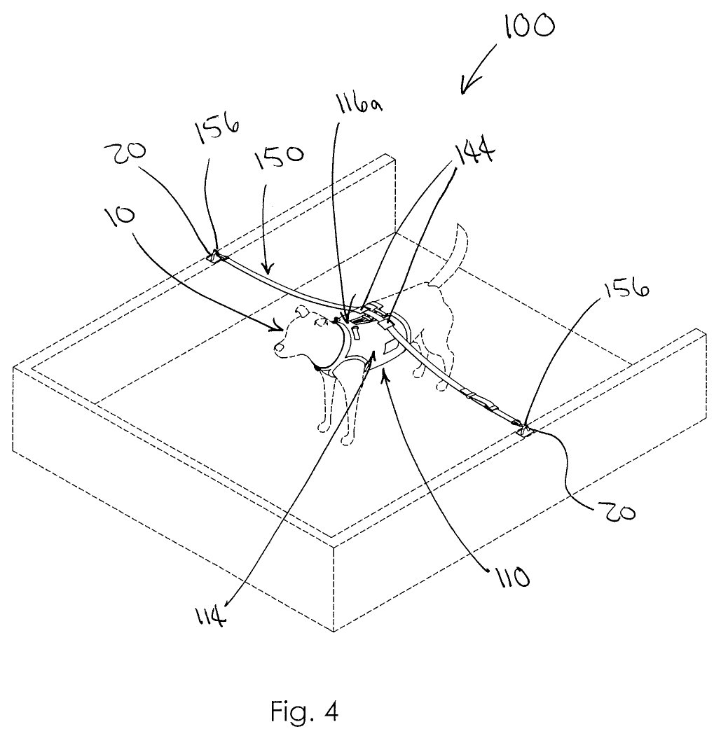

As shown in FIG. 2, a ring 130 (e.g., a D-ring) may be coupled to the vest 110 at one or both shoulder areas 124, and a ring 132 (e.g., a D-ring) may be coupled to the vest 110 at the front end 112a adjacent the neck opening 118 (e.g., at the top 116a or bottom 116b). Various loops 140 may also be coupled to the vest 110. For example, a lateral loop 142 may be coupled to the vest 110 at one or both sides 114, and at least one crossing loop 144 may be coupled to the vest 110 at the top 116a. Two crossing loops 144 are included in the embodiment shown in FIG. 2, and the crossing loops 144 are in line with one another to allow the strap 150 to pass through both crossing loops 144 simultaneously (FIG. 4).

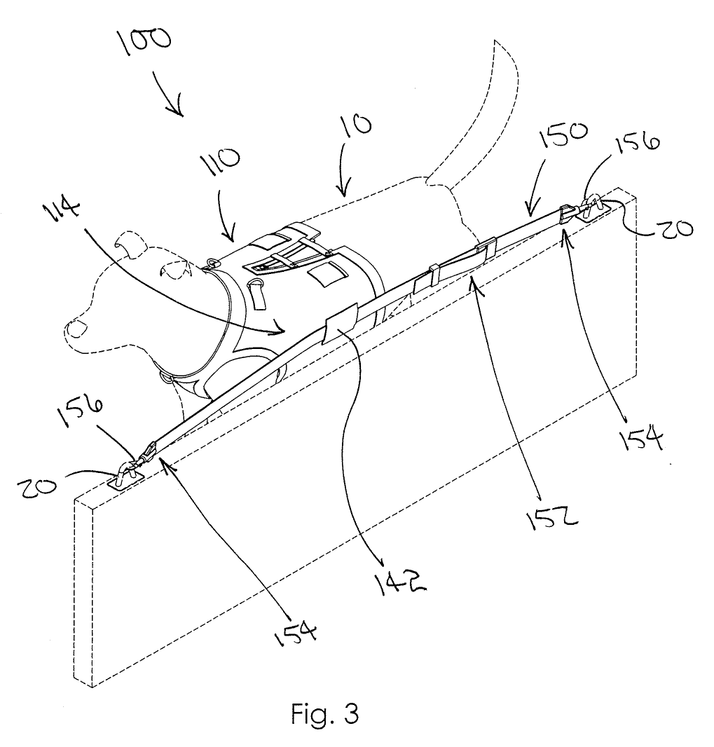

The strap 150 may have an adjustable length (e.g., may include a length-adjusting mechanism 152, as shown in FIG. 3), and the strap 150 is configured to pass through the loops 140 (FIGS. 3 and 4). Opposed ends 154 of the strap 154 may include fasteners 156 (FIG. 3), and the fasteners 156 may be configured for attachment to attachment points 20 (e.g., truck bed anchors shown in FIGS. 3 and 4, LATCH anchors, seatbelt end release devices, etc.).

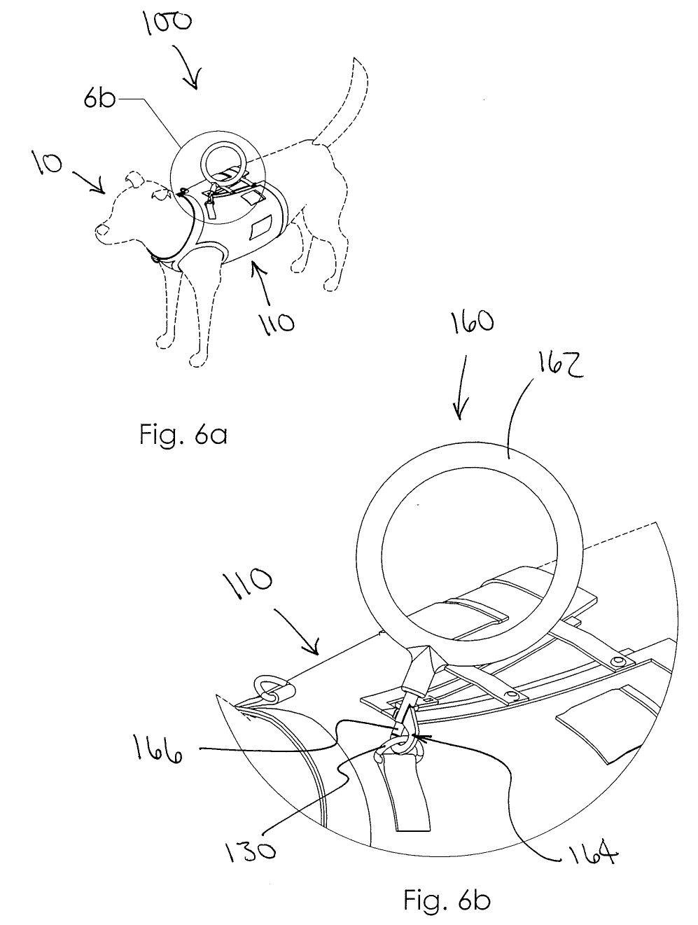

As shown in FIG. 6b, a transition handle 160 may be included. The transition handle 160 has a grip portion 162 and an attachment portion 164. The grip portion 162 is rigid and may be circular or other appropriate shapes, and the attachment portion 164 may be a fastener 166. The transition handle 160 may have a nonextendable length, or in other words, may have a fixed length from the fastener 166 to the end of the grip portion 162.

The ring(s) 130 at shoulder area(s) 124 and the ring 132 adjacent the neck opening 118 may be configured for attachment to the fastener 166 of the transition handle 160 and/or the fasteners 156 of the strap 150.

In use, the restraint system 100 may be employed in various ways to guide and restrain the animal 10 (e.g., a dog). The vest 110 is first placed on the animal 10, with the animal's neck 12 passing through the neck opening 118 and the animal's front legs passing through the leg openings 122. As shown in FIGS. 6a and 6b, the transition handle 160 may be attached to the vest 110 by coupling the fastener 166 to a ring 130 at a shoulder area 124, and the rigidity of the grip portion 162 and the location of the ring 130 may allow a user to easily guide and maintain the dog using the transition handle 160.

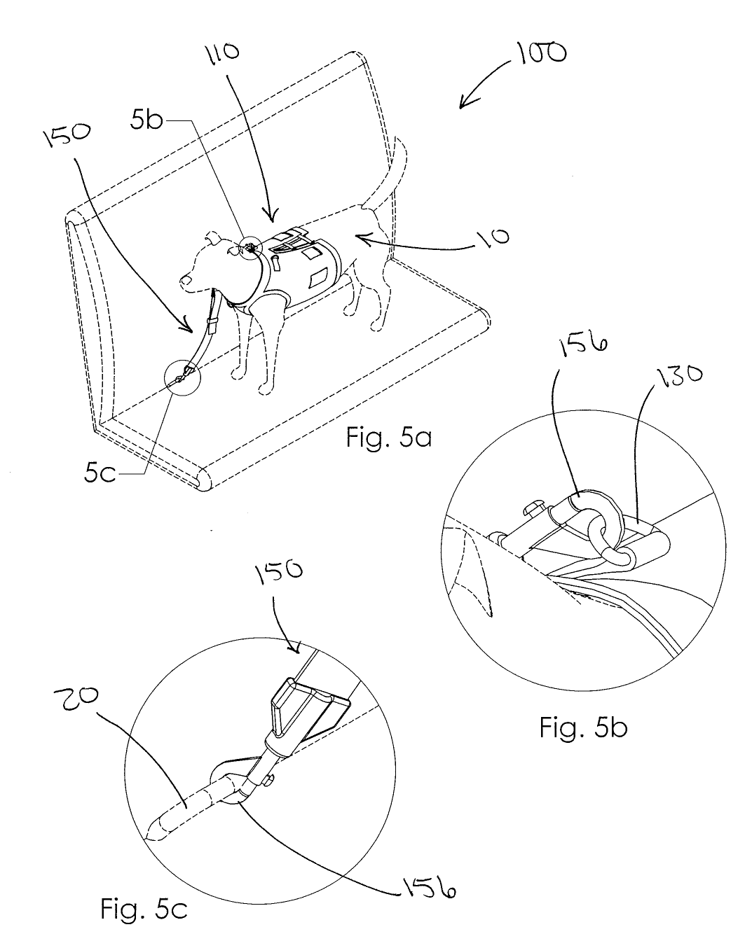

To closely tether the animal 10 to an attachment point 20, one fastener 156 of the strap 154 may be coupled to the attachment point 20 (FIG. 5c) and the other strap fastener 156 may be coupled to a ring 130 at a shoulder area 124 (FIG. 5b) or the ring 132 adjacent the neck opening 118.

To tether the animal 10 while allowing the animal 10 limited freedom to move generally linearly, the strap 150 may pass through one or more loop 140 while the fasteners 156 are utilized. For example, as shown in FIG. 3, the strap 150 may pass through a lateral loop 142 and the strap fasteners 156 may be coupled to separate attachment points 20. With the strap 150 generally taut, the strap 150 extends along the side 114 of the vest 110 and allows the vest 110 and the animal 10 to move forward and rearward. In another example, as shown in FIG. 4, the strap 150 may pass through one or both crossing loops 144 and the strap fasteners 156 may be coupled to separate attachment points 20. With the strap 150 generally taut, the strap 150 extends across the top 116a from one side 114 to the other side 114 and allows the vest 110 and the animal 10 to move sideways.

It is understood that while certain forms of this invention have been illustrated and described, it is not limited thereto except insofar as such limitations are included in the following claims and allowable functional equivalents thereof.

1. An animal restraint system, comprising:
a vest configured to surround a forward portion of an animal extending from around said animal's neck to a location adjacent a rear end of said animal's rib cage; said vest having front and rear ends, opposed first and second sides, a top, a bottom, a neck opening at said front end, two leg openings, and first and second shoulder areas; said shoulder areas being at said top generally adjacent said animal's shoulders when said vest is worn by said animal;
a ring coupled to said vest at said first shoulder area;
a first lateral loop coupled to said vest at said first side;
a first crossing loop coupled to said vest at said top; and
a strap configured to pass through said first lateral loop and said first crossing loop, respectively; said strap having opposed ends with fasteners configured for attachment to vehicle attachment points; said strap extending along said first side when said strap passes through said first lateral loop and said fasteners are utilized; said strap extending across said top from said first side to said second side when said strap passes through said first crossing loop and said fasteners are utilized.

2. The system of claim 1, wherein said vest includes adjustment means.

3. The system of claim 1, further comprising a ring coupled to said vest at said front end adjacent said neck opening, said ring adjacent said neck opening being configured for attachment to at least one said fastener, said ring at said first shoulder area being configured for attachment to at least one said fastener.

4. The system of claim 3, wherein said strap has an adjustable length.

5. The system of claim 4, further comprising:
a second lateral loop coupled to said vest at said second side, said strap extending along said second side when said strap passes through said second lateral loop and said fasteners are utilized;
a second crossing loop coupled to said vest at said top, said first and second crossing loops being in line with one another to allow said strap to pass through said first and second crossing loops simultaneously; and
a ring coupled to said vest at said second shoulder area, said ring at said second shoulder area being configured for attachment to at least one said fastener.

6. The system of claim 5, further comprising a transition handle with a fastener configured to selectively attach to said ring at said first shoulder area, said ring at said second shoulder area, and said ring adjacent said neck opening.

7. The system of claim 6, wherein:
said vest is constructed of quilted fabric and includes reinforcing adjacent said neck opening and said two leg openings; and
said vest includes adjustment means.

8. The system of claim 7, wherein said ring at said first shoulder area is a D-ring, said ring at said second shoulder area is a D-ring, and said ring adjacent said neck opening is a D-ring.

9. The system of claim 1, further comprising a transition handle having a grip portion and an attachment portion, said attachment portion being a fastener configured to selectively attach to said ring at said first shoulder area, said grip portion being rigid, said transition handle having a nonextendable length.

10. A canine restraint system, comprising:
a vest configured to surround a forward portion of a dog extending from around said dog's neck to a location adjacent a rear end of said dog's rib cage; said vest having front and rear ends, opposed first and second sides, a top, a bottom, a neck opening at said front end, two leg openings, and first and second shoulder areas; said shoulder areas being at said top generally adjacent said dog's shoulders when said vest is worn by said dog;
a ring coupled to said vest at said first shoulder area;
a first lateral loop coupled to said vest at said first side;
a first crossing loop coupled to said vest at said top; and
a strap configured to pass through said first lateral loop and said first crossing loop, respectively; said strap having opposed ends with fasteners configured for attachment to vehicle attachment points; said strap extending along said first side when said strap passes through said first lateral loop and said fasteners are utilized, whereby allowing said vest to move forward and rearward; said strap extending across said top from said first side to said second side when said strap passes through said first crossing loop and said fasteners are utilized, whereby allowing said vest to move sideways.

11. The system of claim 10, wherein said strap has an adjustable length.

12. The system of claim 11, further comprising a transition handle having a grip portion and an attachment portion, said attachment portion being a fastener configured to selectively attach to said ring at said first shoulder area, said grip portion being rigid, said transition handle having a nonextendable length.

13. The system of claim 12, further comprising:
a second lateral loop coupled to said vest at said second side; said strap extending along said second side when said strap passes through said second lateral loop and said fasteners are utilized, whereby allowing said vest to move forward and rearward; and
a ring coupled to said vest at said second shoulder area, said ring at said second shoulder area being configured for attachment to at least one said fastener.

14. The system of claim 13, further comprising a second crossing loop coupled to said vest at said top, said first and second crossing loops being in line with one another to allow said strap to pass through said first and second crossing loops simultaneously.

15. An animal restraint system, comprising:
a vest configured to surround a forward portion of an animal extending from around said animal's neck to a location adjacent a rear end of said animal's rib cage; said vest having front and rear ends, opposed first and second sides, a top, a bottom, a neck opening at said front end, two leg openings, and first and second shoulder areas; said shoulder areas being at said top generally adjacent said animal's shoulders when said vest is worn by said animal;
a ring coupled to said vest at said first shoulder area;
first and second loops coupled to said vest and being angularly offset from one another; and
a strap configured to pass through said first and second loops, respectively; said strap having opposed ends with fasteners configured for attachment to attachment points; said vest being able to move in substantially only one direction when said fasteners are coupled to said attachment points, said strap is generally taut, and said strap passes through said first loop; said vest being able to move in substantially only another direction when said fasteners are coupled to said attachment points, said strap is generally taut, and said strap passes through said second loop.

16. The system of claim 15, further comprising a transition handle having a grip portion and an attachment portion, said attachment portion being a fastener configured to selectively attach to said ring at said first shoulder area, said grip portion being rigid, said transition handle having a nonextendable length.

17. The system of claim 16, wherein said strap has an adjustable length.

18. The system of claim 16, further comprising a ring coupled to said vest at said front end adjacent said neck opening, said ring adjacent said neck opening being configured for attachment to at least one said fastener.

19. The system of claim 18, wherein:
said vest is constructed of quilted fabric and includes reinforcing adjacent said neck opening and said two leg openings; and
said vest includes adjustment means.

20. The system of claim 19, wherein said ring at said first shoulder area is a D-ring and said ring adjacent said neck opening is a D-ring.
